(19) United States
(12) Patent Application Publication
(10) Pub. No.: US 2018/0209315 A1
(43) Pub. Date: Jul. 26, 2018

(54) METHOD FOR METERING A REACTANT INTO AN EXHAUST GAS PATH OF AN INTERNAL COMBUSTION ENGINE, AND INTERNAL COMBUSTION ENGINE

(71) Applicant: MTU FRIEDRICHSHAFEN GMBH, Friedrichshafen (DE)

(72) Inventors: Joachim SCHWARTE, Langenargen (DE); Samuel VOGEL, Bad Waldsee (DE); Alexander KOVACEVIC, Langenargen (DE); Marc HEHLE, Konstanz (DE)

(21) Appl. No.: 15/747,308

(22) PCT Filed: Jul. 15, 2016
(86) PCT No.: PCT/EP2016/001240

§ 371 Date: Jan. 24, 2018

(30) Foreign Application Priority Data
Jul. 24, 2015 (DE) 102015214067.9
Sep. 4, 2015 (DE) 102015217029.2

(51) Int. Cl. F01N 3/20; B01D 53/94

(52) U.S. Cl. CPC F01N 3/208; B01D 53/9495; B01D 53/9418; F02B 37/00; F01N 2610/146; F01N 2900/08; F01N 2610/02

(57) ABSTRACT

A method for metering a reactant into an exhaust gas path of an internal combustion engine, wherein the reactant is introduced into an area of the exhaust gas path in which pressure surges in the exhaust gas stream, generated by a charge exchange of the internal combustion engine, contribute to breakdown of droplets of the reactant, wherein a metering device for metering the reactant is activated at a variable metering frequency, depending on an operating point of the internal combustion engine.

The invention relates to a method for metering a reactant into an exhaust gas path of an internal combustion engine, and to an internal combustion engine.

There can be a metering release for metering in a reactant as a rule only above an exhaust gas temperature of 250° C., in particular if the reactant is a reducing agent in the form of a urea/water solution, because otherwise deposits of the reactant can occur. This means that engine map ranges of an internal combustion engine, in which engine map ranges relatively low exhaust gas temperatures are achieved, cannot be covered by way of metering in of the reactant. This applies, in particular, to engine map ranges at a high rotational speed and a low load. This in turn implies, in particular, an improvable cycle conversion of nitrogen oxides at a catalytic converter for the selective catalytic reduction of nitrogen oxides in a test cycle for the internal combustion engine. It is shown, furthermore, that reactant is typically metered into an exhaust gas path of an internal combustion engine at a constant metering frequency, for example at a constant metering frequency of 1 Hz. Here, quantity control takes place, in particular, by way of actuation of a metering valve in a pulse width modulated manner. It is disadvantageous here that the flow conditions in the exhaust gas path can be very different in a manner which is dependent on an operating point of the internal combustion engine. The constant metering frequency results in boundary conditions, which are different in a manner which is dependent on the operating point, for the preparation and mixing of the reactant with the exhaust gas, and therefore, in particular, in a high range of variation of a uniform distribution of the reactant in the exhaust gas. This in turn has a disadvantageous influence, in particular, on the efficiency of the selective catalytic reduction of nitrogen oxides (SCR) in a manner which is dependent on the operating point.

The invention is based on the object of providing a method and an internal combustion engine, the abovementioned disadvantages not occurring.

The object is achieved by the subjects of the independent claims being provided. Advantageous refinements result from the subclaims and the description.

The object is achieved, in particular, by a method for metering a reactant into an exhaust gas path of an internal combustion engine being provided, the reactant being introduced into a region of the exhaust gas path, in which region pressure shocks in the exhaust gas stream which are produced by way of a gas exchange, in particular by way of at least one outlet valve, of the internal combustion engine contribute to a disintegration of droplets of the reactant, that is to say are suitable for this purpose, a metering device for metering in the reactant being actuated at a variable metering frequency in a manner which is dependent on an operating point of the internal combustion engine. By virtue of the fact that the reactant is metered into a region of the exhaust gas path, in which region pressure shocks which are generated, in particular, in the outlet stroke, which is also called the exhaust stroke, of the internal combustion engine contribute to a disintegration, in particular a secondary disintegration, of the reactant droplets, said reactant is evaporated more rapidly and efficiently, which results in a more homogeneous mixture in the gaseous phase downstream. It is shown, furthermore, that a region of the exhaust gas path, in which region said condition is met, is arranged so as to be comparatively close to the combustion chamber, with the result that there are increased exhaust gas temperatures here in the entire engine map of the internal combustion engine. The metering release can therefore take place in a considerably wider engine map range, with the result that, in particular, the cycle conversion at an SCR catalytic converter can be increased. On account of the variable metering frequency, at which the metering device is actuated, said metering device can be adapted to different flow conditions in the exhaust gas path, in particular in a manner which is dependent on an instantaneous operating point of the internal combustion engine. The range of variation for the uniform distribution of the reactant in the exhaust gas can therefore be reduced considerably, and a conversion at an SCR catalytic converter can preferably be homogenized over a substantially extended engine map range of the internal combustion engine. A region of the exhaust gas path, in which region the pressure shocks in the exhaust gas stream which are produced in the outlet stroke of the internal combustion engine contribute to the secondary disintegration of the reactant droplets, is, in particular, a region, in which an amplitude of said pressure shocks is high enough to bring about a droplet disintegration.

Here and in the following text, a reactant is generally understood to mean a reagent which is injected into the exhaust gas path and is provided for conversion with the exhaust gas, in particular at a catalytic converter which is set up for this purpose. Here, the reagent is preferably metered in in the liquid phase. The reactant is preferably a reducing agent, in particular for use as reducing agent for the selective catalytic reduction of nitrogen oxides at a catalytic converter which is set up for this purpose (SCR catalytic converter), and is particularly preferably a urea/water solution. As an alternative or in addition, however, it is also possible that a reactant for another exhaust gas aftertreatment reaction is introduced into the exhaust gas path. It is possible, in particular, that a hydrocarbon or a hydrocarbon mixture for conversion at an oxidation catalytic converter is introduced as reactant.

The metering device is preferably actuated in a manner which is dependent on the rotational speed, that is to say dependent on a rotational speed of the internal combustion engine, at a variable metering frequency, in particular at a metering frequency which is dependent on the rotational speed. This makes an adaptation of the metering of the reactant possible, in particular to the pressure shocks in the exhaust gas stream, with the result that said pressure shocks can be utilized in an optimum manner for disintegrating the reactant droplets and therefore for distributing the reactant in the exhaust gas.

One development of the invention provides that the metering device is actuated synchronously with respect to a defined stroke of the internal combustion engine, in particular in a pulsed manner. Here, in particular, an actuation of the metering device means an actuation for opening, that is to say an activation or opening of the metering device. The coupling of the actuation of the metering device to a defined stroke of the internal combustion engine makes an adaptation of the metering of the reactant to the flow in the exhaust gas path downstream of the combustion chambers of the internal combustion engine possible in a special way, with the result that pressure shocks in the exhaust gas stream can be utilized in an optimum manner for distributing the reactant.

Here, the term “synchronously” means, in particular, that the actuation of the metering device is coupled temporarily to another event, in particular the defined stroke of the internal combustion engine. This can mean that the metering device is actuated at the same time as the beginning of a stroke of the internal combustion engine, which corresponds to a phase shift of 0°. A defined phase shift which is different than 0° is preferably used, however. This allows the preparation of the reactant in the exhaust gas stream to be optimized further, in particular in respect of dead times with regard to the exhaust gas stream in a manner which is dependent on an actual arrangement of the metering device in the exhaust gas path.

The defined phase shift can preferably be selected in a variable manner, in particular in a manner which is dependent on an operating point of the internal combustion engine, that is to say in a manner which is dependent on the operating point. The defined phase shift is preferably stored in an engine map in a manner which is dependent on the operating point.

One development of the invention provides that the reactant is metered into the exhaust gas path upstream of a turbine of an exhaust gas turbocharger. The arrangement of the metering device upstream of the turbine of the exhaust gas turbocharger represents, in particular, a possibility for realizing metering of the reactant into a region of the exhaust gas path, in which region pressure shocks in the exhaust gas stream which are produced by way of a gas exchange of the internal combustion engine are suitable for a secondary disintegration of droplets of the reactant. Pressure shocks of this type downstream of the turbine namely typically still prevail only in considerably damped form, said pressure shocks no longer being able, in particular, to bring about a disintegration here. In contrast, an amplitude of the pressure shocks upstream of the turbine of the exhaust gas turbocharger is still high enough for the abovementioned purpose. A further advantage of the metering in of the reactant upstream of the turbine results from the fact that said turbine can be utilized as a very efficient mixing device for mixing the reactant with the exhaust gas. This results in a considerably reduced installation space requirement for the mixing section of the reactant, it being possible, in particular, for additional mixing elements to be saved or to be of smaller design than if the reactant is injected into the exhaust gas path downstream of the turbine. A pressure loss across the mixing elements can be reduced or minimized by way of the omission or the smaller design of mixing elements of this type, which has a favorable effect on the exhaust gas back pressure for the internal combustion engine and therefore also on the fuel consumption thereof. At the same time, the turbine brings about a very satisfactory uniform distribution of the reactant in the exhaust gas. It is shown, furthermore, that a higher exhaust gas temperature prevails upstream of the turbine of the exhaust gas turbocharger than downstream of the turbine, with the result that this in turn contributes to a metering release in a considerably extended engine map range of the internal combustion engine. Furthermore, a housing of the turbine can be used as an evaporator, in particular because said housing typically has high temperatures.

One development of the invention provides that the reactant is metered into an exhaust gas collecting space which adjoins (preferably directly) at least one combustion chamber of the internal combustion engine. This is advantageous because particularly high exhaust gas temperatures prevail here, with the result that the metering release can take place over a particularly wide engine map range. An exhaust gas collecting region is, in particular, a region of the exhaust gas path, in which region exhaust gas from a plurality of combustion chambers of the internal combustion engine is combined. The exhaust gas collecting region can be configured, in particular, as an exhaust manifold. The metering in of the reactant preferably takes place at least so close to at least one combustion chamber and/or in a manner which is adapted to the arrangement of at least one combustion chamber relative to the exhaust gas collecting region in such a way that pressure shocks from the at least one combustion chamber can be used for the secondary disintegration. The metering of the reactant preferably takes place centrally into the exhaust gas collecting region. Particularly high flow pulses, in particular pressure shocks in the exhaust gas flow, otherwise result in the exhaust gas collecting region during every gas exchange of a combustion chamber. If the reactant is metered centrally into the exhaust gas collecting region, pressure shocks of this type from all the combustion chambers of the internal combustion engine can be used particularly efficiently. A droplet disintegration of the reactant is improved considerably by way of the intermittently varying relative speed between the exhaust gas and the reactant, in particular in addition to the high exhaust gas temperature in the exhaust gas collecting region. Here, in particular, every outlet stroke of a combustion chamber of the internal combustion engine is harnessed for the secondary droplet disintegration by way of pulses of the exhaust gas stream. An arrangement of the metering device in the exhaust gas collecting region is therefore, in particular, an arrangement, in which pressure shocks in the exhaust gas stream which are produced by way of a gas exchange, in particular by way of at least one outlet valve, of the internal combustion engine are suitable for and contribute to a disintegration of droplets of the reactant. It is also shown at the same time that the exhaust gas collecting region is arranged upstream of a turbine of an exhaust gas turbocharger if the internal combustion engine has an exhaust gas turbocharger.

One development of the invention provides that the reactant is metered in synchronously with an ignition sequence, in particular synchronously with a defined stroke of at least one combustion chamber of the internal combustion engine, preferably with a defined phase shift. This makes a particularly efficient adaptation of the metering in of the reactant to the pressure shocks in the exhaust gas stream possible. It is possible that the actuation of the metering device is coupled to precisely one defined stroke of precisely one combustion chamber of the internal combustion engine. The metering device is then actuated in each case only once within an ignition sequence of an internal combustion engine which has a plurality of combustion chambers. It is also possible, however, that the metering device is actuated with a defined (preferably the same) stroke of a plurality of combustion chambers. In this case, the metering device is actuated multiple times within an ignition sequence of the internal combustion engine. It is also possible, in particular, that the internal combustion engine is actuated within the ignition sequence in a defined stroke of each combustion chamber.

One development of the invention provides that the metering device is actuated synchronously with an exhaust stroke of at least one combustion chamber of the internal combustion engine, preferably with a defined phase shift. It is also possible here that the metering device is actuated synchronously with an exhaust stroke of precisely one combustion chamber, or else synchronously with exhaust strokes of a plurality of combustion chambers, in particular also synchronously with exhaust strokes of all combustion chambers of the internal combustion engine. The synchronization of the actuation of the metering device with an exhaust stroke brings about coupling of the metering in of the reactant in a particularly efficient way to the pressure shocks which result in the exhaust gas path during the gas exchange of the combustion chambers.

It is preferably provided here that the actuation of the metering device is coupled to an opening time of an outlet valve which is assigned to the combustion chamber, particularly preferably with a defined phase shift which can be 0° or can have a finite value which is different than zero. The phase shift can preferably be selected to be variable, in particular to be dependent on the operating point. The defined phase shift is preferably stored in an engine map in a manner which is dependent on the operating point.

One development of the invention provides that the metering device is actuated in a pulse width modulated manner, in order to set a metered quantity of reactant. In this way, very precise and sensitive metering of the reactant into the exhaust gas path is possible, it being possible for the pulse width modulated actuation to be adapted to the instantaneous metering frequency, in particular in a manner which is dependent on the operating point. It can thus be avoided that a greater and possibly excessively great quantity of reactant is metered in only on account of an increased metering frequency, it conversely being possible for it to be avoided that a smaller or else excessively small quantity of reactant is metered into the exhaust gas path on account of a reduced rotational speed and therefore a reduced metering frequency.

The object is also achieved by an internal combustion engine being provided which has at least one combustion chamber and an exhaust gas path, in which a metering device for metering a reactant into the exhaust gas path is arranged in such a way that the reactant can be introduced into a region of the exhaust gas path, in which region pressure shocks in the exhaust gas stream which are generated by way of a gas exchange, in particular by way of at least one outlet valve, of the internal combustion engine contribute to a disintegration of droplets of the reactant, that is to say are suitable for this purpose, the internal combustion engine having a control device which is set up to actuate the metering device at a variable metering frequency in a manner which is dependent on an operating point of the internal combustion engine. The internal combustion engine is particularly preferably set up to carry out a method in accordance with one of the above-described embodiments. Here, the advantages which have already been described in conjunction with the method are realized, in particular.

The internal combustion engine preferably has a catalytic converter along the exhaust gas path, which catalytic converter is set up for the selective catalytic reduction of nitrogen oxides, in particular is therefore what is known as an SCR catalytic converter.

In addition or as an alternative, it is possible that the internal combustion engine has a catalytic converter along the exhaust gas path, which catalytic converter is set up and configured as an oxidation catalytic converter. At said catalytic converter, for example, a hydrocarbon or a hydrocarbon mixture can be converted as reactant. A “conversion with the exhaust gas” is also otherwise understood to mean a conversion with residual oxygen which is contained in the exhaust gas. To this extent, the conversion of a hydrocarbon or a hydrocarbon mixture, in particular at an oxidation catalytic converter, is also a conversion with exhaust gas.

The metering device is preferably arranged upstream of a turbine of an exhaust gas turbocharger of the internal combustion engine.

It is provided in one preferred exemplary embodiment that the metering device is arranged at an exhaust gas collecting region, in particular centrally at the exhaust gas collecting region, in particular an exhaust gas manifold, in such a way that the reactant can be metered into the exhaust gas collecting region, in particular centrally into the exhaust gas collecting region. As an alternative or in addition, the metering device is positioned at least so close to at least one combustion chamber and/or adapted to the arrangement of at least one combustion chamber relative to the exhaust gas collecting region in such a way that pressure shocks from the at least one combustion chamber can be used for the secondary disintegration.

One exemplary embodiment of the internal combustion engine is also preferred which is distinguished by the fact that the internal combustion engine is configured as a low speed engine, as a medium speed engine or as a fast speed engine. Here, the advantages according to the invention are realized, in particular, independently of the specifically reached rotational speeds of the internal combustion engine, in particular in all rotational speed ranges.

The internal combustion engine is preferably configured as a reciprocating piston engine. It is possible that the internal combustion engine is set up for driving a passenger motor vehicle, a truck or a commercial vehicle. In one preferred exemplary embodiment, the internal combustion engine serves to drive, in particular, heavy land or water vehicles, for example mining vehicles, trains, the internal combustion engine being used in a locomotive or a railcar, or ships. The use of the internal combustion engine is also possible for driving a vehicle which serves for defense, for example a tank. One exemplary embodiment of the internal combustion engine is preferably also used in a stationary manner, for example for stationary energy supply in emergency power operation, continuous duty operation or peak load operation, the internal combustion engine preferably driving a generator in this case. The stationary application of the internal combustion engine for driving auxiliary assemblies, for example fire extinguishing pumps on oil rigs, is also possible. Furthermore, an application of the internal combustion engine in the field of the extraction of fossil raw materials and, in particular, fuels, for example oil and/or gas, is possible. The use of the internal combustion engine in the industrial field or in the construction field is also possible, for example in a construction or building machine, for example in a crane or an excavator. The internal combustion engine is preferably configured as a diesel engine, as a gasoline engine, or as a gas engine for operating with natural gas, biogas, special gas or another suitable gas. If, in particular, the internal combustion engine is configured as a gas engine, it is suitable for use in a cogeneration plant for stationary power generation.

It is shown overall that the invention provides, in particular, an integration of the evaporation and mixing section upstream of a turbine of an exhaust gas turbocharger, a higher exhaust gas temperature and a higher exhaust gas pressure being used for the preparation of the reactant, it being possible for the turbine to be used, in particular as a mixer and for the turbine housing to be used as an evaporator. Furthermore, a metering valve which can be actuated at a variable frequency is used, suitable metering of the reactant into the exhaust gas line, which metering is dependent on the operating point, being provided by way of the adaptation of the metering frequency. In this way, an adaptation of the metering takes place by way of the gas dynamics, in particular by way of an outlet stroke for utilization for the secondary droplet disintegration of the reactant.

This advantageously results in an extension of the evaporation and mixing section with an identical amount of installation space. A sufficiently high uniform distribution of the reactant in the overall engine map of the internal combustion engine can be provided, an application-independent preparation of the reactant being possible, in particular. A metering release can take place in a wider engine map range on account of the higher temperature level at the location of the metering, which preferably results in an increase in the SCR cycle conversion with a simultaneous avoidance of deposits of the reactant in the exhaust gas path.

An application of the metering system close to the engine is possible, which results in application independence. The installation space of the overall exhaust gas aftertreatment system can be reduced. At the same time, pressure losses can be reduced for an improved exhaust gas back pressure, which also has a favorable effect on the fuel consumption of the internal combustion engine. Overall, the manufacturing and operating costs of the exhaust gas aftertreatment means are also reduced because, for example, mixing elements can be dispensed with.

The description of the method firstly and the internal combustion engine secondly are to be understood to be complementary to one another. Features of the internal combustion engine which have been described explicitly or implicitly in conjunction with the method are preferably features of one preferred exemplary embodiment of the internal combustion engine, individually or combined with one another.

Method steps which have been described explicitly or implicitly in conjunction with the internal combustion engine are preferably steps of one preferred embodiment of the method, individually or combined with one another. Said method is preferably distinguished by at least one method step which is conditional on at least one feature of an exemplary embodiment of the internal combustion engine, which exemplary embodiment is according to the invention or preferred.

The internal combustion engine is preferably distinguished by at least one feature which is conditional on at least one step of an embodiment of the method, which embodiment is according to the invention or preferred.

In the following text, the invention will be described in greater detail using the drawing, in which:

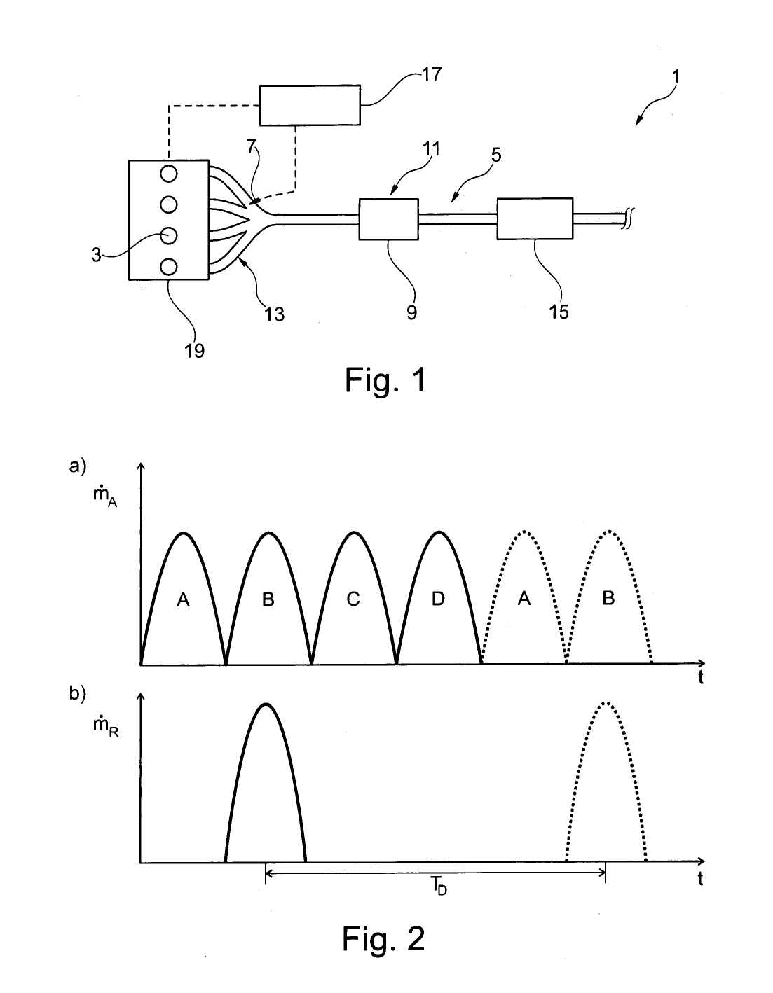

FIG. 1 shows a diagrammatic illustration of one exemplary embodiment of an internal combustion engine, and

FIG. 2 shows a diagrammatic illustration of one embodiment of the method.

FIG. 1 shows a diagrammatic illustration of one exemplary embodiment of an internal combustion engine 1. The internal combustion engine has at least one combustion chamber 3 (four combustion chambers here, of which only one is denoted by the designation 3 for improved clarity). Moreover, the internal combustion engine 1 has an exhaust gas path 5, in which a metering device 7 for metering a reactant into the exhaust gas path 5 is arranged.

The reactant is preferably a reducing agent, in particular for use as a reducing agent for the selective catalytic reduction of nitrogen oxides, particularly preferably a urea/water solution. As an alternative or in addition, it is also possible, however, that a reactant for another exhaust gas aftertreatment reaction is introduced into the exhaust gas path 5. It is possible, in particular, that a hydrocarbon or a hydrocarbon mixture for conversion at an oxidation catalytic converter is introduced as reactant.

Here, the metering device 7 is arranged in such a way that the reactant is introduced into a region of the exhaust gas path 5, in which region pressure shocks in the exhaust gas stream which are produced by way of a gas exchange of the internal combustion engine 1 contribute to a disintegration of droplets of the reactant. It is shown here, in particular, that the metering device 7 is arranged upstream of a turbine 9 of an exhaust gas turbocharger 11. In particular, the metering device 7 is arranged at an exhaust gas collecting region 13 which directly adjoins the at least one combustion chamber 3 of the internal combustion engine 1 and can be configured as an exhaust gas manifold. Here, it is preferably arranged centrally at the exhaust gas collecting region 13, with the result that the reactant can preferably be metered centrally into the exhaust gas collecting region 13.

The exhaust gas path 5 preferably has a catalytic converter 15 downstream of the exhaust gas turbocharger 11, at which catalytic converter 15 the reactant can be converted with the exhaust gas. The catalytic converter 15 is particularly preferably configured as an SCR catalytic converter.

The internal combustion engine 1 has a control device 17 which is set up to actuate the metering device at a variable metering frequency in a manner which is dependent on an operating point of the internal combustion engine 1. To this end, the control device 17 is preferably operatively connected firstly to an engine block 19 of the internal combustion engine 1, in particular to a rotational speed sensor (not shown) for detecting the rotational speed of said internal combustion engine 1, and to the metering device 7.

The control device 17 is set up, in particular, to actuate the metering device 7 in a manner which is dependent on the rotational speed, that is to say dependent on a rotational speed of the internal combustion engine 1. Furthermore, the control device 17 is preferably configured to actuate the metering device synchronously with a defined stroke of the internal combustion engine, in particular in a pulsed manner, preferably with a defined phase shift, preferably synchronously with an ignition sequence of the internal combustion engine 1, in particular with a defined stroke of at least one combustion chamber 3. The control device 17 is particularly preferably set up to actuate the metering device 7 synchronously with an exhaust stroke of at least one combustion chamber of the internal combustion engine.

The internal combustion engine 1 is preferably configured as a four stroke reciprocating piston engine, a sequence of four strokes of each combustion chamber 3 having an intake stroke, a compression stroke, a work stroke and an exhaust stroke. The corresponding method of operation of an internal combustion engine 1 is generally known, with the result that it will not be described in greater detail.

The metering of the reactant into a region which is close to the combustion chamber and, in particular, into a region, in which pressure shocks in the exhaust gas stream which are produced by way of a gas exchange of the internal combustion engine 1 contribute to a secondary disintegration of droplets of the reactant, necessitates metering in at an elevated exhaust gas temperature, with the result that a metering release can take place in a wider engine map range. At the same time, the pressure shocks aid a rapid and homogeneous distribution of the reactant in the exhaust gas, with the result that, in particular in comparison to an actuation of the metering device 7 at a constant frequency, a homogeneity of the distribution of the reactant in the exhaust gas stream becomes possible, which homogeneity is improved over the engine map of the internal combustion engine 1. Moreover, an arrangement of the metering device 7 upstream of the turbine 9 leads to said turbine 9 being used efficiently as a mixing device, with the result that possible further, additional mixing elements can be dispensed with or at least can be of smaller design. This in turn leads to a configuration of the exhaust gas path 5 which saves installation space, and to a reduction in the exhaust gas back pressure for the internal combustion engine 1, and therefore also to a reduction of the fuel consumption.

The control device 17 is preferably set up to actuate the metering device 7 in a pulse width modulated manner, in particular to set a quantity of reactant which is metered into the exhaust gas path 5.

FIG. 2 shows a diagrammatic illustration of one exemplary embodiment of the method. Here, FIG. 2a) illustrates a schematic, diagrammatic illustration of an ignition sequence of an internal combustion engine 1 having four combustion chambers which are labelled with the letters A, B, C, D. Here, in the diagram, an exhaust gas mass flow \dot{m}_{A} in the exhaust gas path 5 is plotted against the time t, the individual mass flow distributions being assigned in each case to the outlet strokes of the different combustion chambers A, B, C, D.

FIG. 2b) schematically shows a diagram of a mass flow \dot{m}_{R} of the reactant into the exhaust gas path 5 in a manner which is dependent on the time t, as results by way of actuation of the metering device 7. It is shown here that the actuation of the metering device 7 and therefore the mass flow of the reactant are synchronized here with the exhaust stroke of the combustion chamber B, preferably with a defined phase shift. This therefore results in a metering period T_{D} which is dependent on the rotational speed, a metering frequency which is dependent on the rotational speed resulting accordingly.

It is shown overall that an improved distribution of a reactant in an exhaust gas stream can be realized over a wide engine map range of an internal combustion engine 1 by means of the method according to the invention and the internal combustion engine 1.

1-10. (canceled)

11. A method for metering a reactant into an exhaust gas path of an internal combustion engine, comprising the steps of:
introducing the reactant into a region of the exhaust gas path, in which region pressure shocks in an exhaust gas stream which are produced by a gas exchange of the internal combustion engine contribute to a disintegration of droplets of the reactant; and
actuating a metering device for metering in the reactant at a variable metering frequency in a manner dependent on an operating point of the internal combustion engine.

12. The method according to claim 11, including actuating the metering device synchronously with respect to a defined stroke of the internal combustion engine.

13. The method according to claim 12, including actuating the metering device with a defined phase shift with respect to the defined stroke of the internal combustion engine.

14. The method according to claim 11, including metering the reactant into the exhaust gas path upstream of a turbine of an exhaust gas turbocharger.

15. The method according to claim 11, including introducing the reactant into an exhaust gas collecting region that adjoins at least one combustion chamber of the internal combustion engine.

16. The method according to claim 11, including actuating the metering device synchronously with an ignition sequence.

17. The method according to claim 16, including actuating the metering device with a defined stroke of at least one combustion chamber of the internal combustion engine.

18. The method according to claim 17, including actuating the metering device with a defined phase shift.

19. The method according to claim 11, including actuating the metering device synchronously with an exhaust stroke of at least one combustion chamber of the internal combustion engine.

20. The method according to claim 19, including actuating the metering device with a defined phase shift.

21. The method according to claim 11, including actuating the metering device in a pulse width modulated manner in order to set a metered quantity of reactant.

22. An internal combustion engine, comprising:
at least one combustion chamber;
an exhaust gas path;
a metering device arranged in the exhaust gas path for metering a reactant into the exhaust gas path so that pressure shocks in an exhaust gas stream, which are produced by a gas exchange of the internal combustion engine, contribute to a disintegration of droplets of the reactant; and
a control device set up to actuate the metering device at a variable metering frequency in a manner dependent on an operating point of the internal combustion engine.

23. The internal combustion engine according to claim 22, further comprising an exhaust gas turbocharger having a turbine, wherein the metering device is arranged upstream of the turbine.

24. The internal combustion engine according to claim 22, wherein the internal combustion engine is configured as a low speed engine, a medium speed engine or a fast speed engine.
